(19) United States
(12) Patent Application Publication
(10) Pub. No.: US 2006/0005579 A1
(43) Pub. Date: Jan. 12, 2006

(54) Method of making a preform for an optical fiber, the preform and an optical fiber

(75) Inventors: Christian Jacobsen, Virum (DK); Martin Dybendal Nielsen, Kgs. Lyngby (DK)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: CRYSTAL FIBRE A/S, Birkerod (DK)

(21) Appl. No.: 11/154,657

(22) Filed: Jun. 17, 2005

Related U.S. Application Data
(60) Provisional application No. 60/598,119, filed on Aug. 3, 2004.

(30) Foreign Application Priority Data
Jul. 8, 2004 (DK) PA 2004 01078

(51) Int. Cl. C03B 37/018

(52) U.S. Cl. 65/392; 65/424

(57) ABSTRACT

A method of making a preform for an optical fiber includes the steps of providing at least one rod shaped unit having an outer surface of glass, subjecting the at least one rod shaped unit to a laser surface treatment by directing a laser beam onto its outer surface to thereby evaporate glass from the surface, while simultaneously providing a gas flow to thereby remove the evaporated glass, and applying the treated rod shaped unit in intimate contact with a second unit so that at least a part of the surface of the rod shaped unit that has been subjected to a laser surface treatment is in intimate contact with the second unit.

### TECHNICAL FIELD

The invention relates to a method of making a preform for an optical fiber, wherein the preform comprises at least one rod shaped unit used together with another unit. The invention also relates to the preform obtained as well as an optical fiber.

### BACKGROUND ART

The general method of producing optical fibers is to prepare a preform, which has a cross sectional configuration which is similar to the desired cross sectional configuration of the final optical fiber and to draw or extrude the preform to thereby form the final optical fiber.

Optical fibres are fibers which are capable of delivering electromagnetically waves (light) from one point to another. Such fibers e.g. have e.g. application in lasers, communications, imaging and sensing. Conventionally, a typical optical fibre is a long strand of transparent material which is uniform along its length but which has a refractive index varying across its cross-section. For example, a central core region of higher refractive index is surrounded by a cladding region with a lower refractive index. Such a fibre may be made from fused silica with a cladding of pure silica surrounding a core made from silica into which deliberate impurities have been introduced to raise the refractive index. Light is confined in or near the core by the process of total internal reflection which takes place at the boundary between the core and the cladding. In general, a fibre of this type may support more than one guided mode of propagation confined to the core (i.e. multi mode fibre), these modes traveling along the fibre at different phase velocities. However, if the core is made to be sufficiently small, only one guided mode of propagation will be confined to the core, the fundamental mode (i.e. a single mode fibre). A lot of variations of the standard fibers have been developed through the last years, including fibers with stress induced areas e.g. as disclosed in Kun-Hsieh Tsai et al., “General Solutions for Stress-Induced Polarization in Optical Fibers”. Journal of Lightwave Tech., vol. 9, No. 1. January 1991.

More recently, an optical fiber called a photonic crystal fibre (PCF) has been developed. This PCF comprises a cladding made of a transparent material in which an array of holes is embedded along the length of the fibre [J. C. Knight, et al., Opt. Lett. 21 (1996) p. 1547. Errata: Opt. Lett. 22 (1997) p. 484]. The holes are arranged transversely in a periodic array and are filled with a material which has a lower refractive index than the rest of the cladding. The center of the fibre comprises a transparent region which breaks the periodicity of the cladding. Typically, both the core and the cladding are made from pure fused silica and the holes are filled with air. In a variation thereof the PCF comprises transversely arranged rods of another material instead of holes. Such fibers are e.g. disclosed in WO37974 which also discloses the PCFs with transversely arranged holes.

The PCF type are generally produced from rod shaped units which are stacked to form a preform, which thereafter is drawn in one ore more steps to form the final optical fiber. In 2D Photonic band gap structures in fibre form”, T. A. Birks et al. “Photonic Band Gap Materials, Kluwer, 1996 is disclosed a method of producing a preform from rods in the form of capillary tubes by stacking the tubes.

WO 3078338 discloses a method of producing a preform for a microstructured optical fiber wherein a plurality of elongate elements are placed parallel to each other in a vessel where after at least a portion of said vessel is filled with a silica-containing sol, which is dried and sintered.

It is well known that contaminations of the fiber materials with dust or similar may result in increased loss of light in the fiber. Therefore it is normal to remove such dust using a chemical etch e.g. etching with SF₆, NF₃ or aqueous NH₄F—HF as disclosed in WO 4046054.

Methods of producing optical fibers are under constant development in order to reduce the attenuation of the optical fiber.

### SUMMARY OF INVENTION

The objective of the invention is to provide a novel method of producing a preform from which a fiber with low attenuation can be produced.

This objective has been achieved by the invention as it is defined in the claims and further the embodiments of the invention solves other objects as it will be explained in the following.

The inventors of the present invention have thus surprisingly found that by subjecting a rod shaped unit with an outer surface of glass to a laser surface treatment and using this e.g. by stacking it with other rods to form a preform, the fiber drawn from this preform has a very low attenuation compared with a similar fiber produced from a preform where the corresponding rod shaped unit has not been subjected to a laser surface treatment.

An explanation of this effect is believed to be that the surface not only is cleaned by the treatment, but that the cleaning is made in such a way that the fusion to other units of the preform is improved. In ordinary productions of preforms using one or more rod shaped units, readymade glass rods e.g. glass tubes are drawn down from e.g. diameters of tens of millimeters to about 1 mm, known as capillary tubes. These smaller tubes may then again be stacked in a sleeving tube and pulled to fiber. In this way all contaminations and scratches that are present on the readymade tube together with contaminations added in later process steps are embedded in the final preform—hence also in the very center of the later produced fiber. Scratches and contamination are unavoidably leading to a bad fusing which encapsulates different contaminations and open areas between the elements—this has a strong impact on optical loss in the final fiber. Due to the many process steps and handling of the elements involved in producing this type of fiber it is difficult to control the vast number of contamination sources present.

Thanks to the invention this problem has now been overcomed in a simple and economically feasible way.

### DISCLOSURE OF INVENTION

The method according to the invention for making a preform for an optical fibre comprising the steps of
i) providing at least one rod shaped unit comprising an outer surface of glass,
ii) subjecting said at least one rod shaped unit to a laser surface treatment by directing a laser beam onto its outer surface to thereby evaporate glass from the surface, while simultaneously providing a gas flow to thereby remove the evaporated glass, and
iii) applying the treated rod shape unit in intimate contact with a second unit so that at least a part of the surface of the rod shaped unit that has been subjected to a laser surface treatment is in intimate contact with the second unit.

The preform may in principle be for any type of optical fibers which can be using such preform. This includes even standard fibers composed of two types of glass. For example, in this situation a first rod shaped unit could form the core element and this could be inserted in a second hollow rod shaped unit after being subjected to a laser surface treatment or the second unit could be a sol-gel glass as described below. The method has been shown to be extremely beneficial for producing preforms for optical fibers where a plurality of rod shaped units are stacked.

The term “rod shaped unit” means a unit shaped as a solid or hollow oblong unit with a first and a second ends which irrespectively of each other may be open or closed in situations where the rod shaped unit is hollow. The rod shaped unit may preferably have a cross sectional shape which is essentially identical along its length.

In the following we refer to one rod shaped unit when describing the laser surface treatment, but of course it should be understood that the preform could be composed from two or more such as a plurality of rod shaped units which all have been subjected to a laser surface treatment.

The rod shaped unit will in most situations have cross sectional outer periphery which is essentially circular, but in general the shape could be any kind of shape. Thus most preferably the rod shaped unit has a cross sectional outer periphery which is selected from the group consisting of circular, oval, triangular, square formed, pentagonal, hexagonal.

In one embodiment, the rod shaped unit is solid and is composed of the same material in its entirety. In another embodiment, the rod shaped unit is solid and is composed of two or more different materials, e.g. a first material as a tube forming the outer wall of the rod and a second material constituting the core of the rod. The second material may in this connection be any kind of transparent material, such as glass and polymer.

In one embodiment, the rod shaped unit is a solid unit, of one or more types of glass, such as a solid rod unit with a core of another type of glass, such as a glass with another refractive index, such as a glass with a different doping status than the cladding surrounding the core.

In one embodiment of the method according to the invention, the rod shaped unit is what is normally referred to as holey. This means that it comprises at least one hole extending along the length of the rod e.g. a glass tube. This holey rod is preferably in the form of a capillary tube, i.e. a glass tube with a through going opening of capillary size for water, e.g. in the range from 0.001 to 0.25 cm.

In one embodiment, the rod shaped unit is a holey rod comprising two or more holes extending along the length of the rod. Such holey unit with two or more holes may e.g. be produced from fusion of two or more single holey rod shaped units, which may or may not be laser surface treated. For an optimal solution it is desired that the single holey rod shaped units also are subjected to a laser surface treatment.

The holey rod shaped unit may be open ended or they may have one or both ends sealed, such as it is known in the art. In situation where the holey rod has sealed ends it may be filled with a desired gas.

The term “glass” includes in principle any type of transparent glass suitable for optical fibers, including but not limited to amorphous silica glass which has a silica content of at least 90% by weight, such as preferably at least 95% by weight. Other glasses with lower amount of silica such a lime-silica glass may be used, but in general, these types of glasses absorb light of certain wavelength, and are therefore only suitable for use outside the area where they have large absorbence.

Preferably the glass is in one embodiment of fused silica with or without doping materials.

In one embodiment, the glass is doped glass, such as glass doped with one or more of the components selected from the group consisting of Ge, Al, P, Sn, N, B, F, Tm Er, Yb, Nd, Sm, Pr, Ho, and any other components from rare earth metal group. The doping materials are normally added in relatively small quantities, but in one embodiment the glass may comprise up to about 20% by weight of doping materials. Such doped glass and methods for doping are well known in the art. The doping materials may be homogenous distributed or they may be inhomogeneous e.g. higher concentration in a centre section along the centre axis of a rod shaped unit.

The laser surface treatment is performed by directing a laser beam towards the outer surface of the rod shaped unit to be treated and moving the laser beam or the rod shaped unit so that the laser beam passes over the entire outer surface of the rod shaped unit. In this connection the term “outer surface” does not include the end faces of the rod shaped unit. The end faces may as well be subjected to a laser surface treatment but it is not essential for the method of the invention.

In the laser surface treatment the laser beam evaporates the outermost glass material of the rod shaped unit, and simultaneously any dirt and dust are removed or burned of. If laser surface treatment without the application of a gas flow over the surface is used, no significant effect can be seen, probably because the evaporated glass and the removed dirt and dust just are moved for being redeposit when the glass is cooled down again. It has thus been shown to be essential that the evaporated glass together with any dirt and dust are removed from the surface. This is done by providing a gas flow along the surface of the rod shaped unit. By applying a gas flow to remove the evaporated glass, and optionally dirt and dust, the inventors of the present invention have thus made this method highly effective.

The laser beam results in a local heating of the surface of the rod shaped unit which is sufficient to evaporate some of the glass of the surface. Even though the glass thus is locally heated to such high temperatures, it has been found that the risk of having undesired melting and/or deformation of the glass is sufficiently low so that it is possible to avoid damage due to overheating, and that the treatment time is relatively simple to optimize in order to avoid such undesired effect.

It is believed that the gas flow also has the effect of cooling the glass sufficiently fast to assist in avoiding undesired deformation of the rod shaped unit.

Thus it has been found that even in situations where the rod shaped unit is a holey unit, the laser surface treatment can be performed without damaging the wall, even a thin wall of about 0.1 mm or less.

The laser used for performing the laser surface treatment can in principle be any kind of laser which is emitting a laser beam including a wavelength which is at least partly absorbable by the glass material of the outer surface of the rod shaped unit.

The laser should thus preferably be selected to the glass material to be evaporated.

In one embodiment of the method according to the invention, the laser used for performing the laser surface treatment being a laser with a laser beam comprising a wavelength with is absorbable by the glass material constituting the outer surface of the at least one rod, the laser beam preferably include a wavelength about 300 nm or less, such as between 130 nm and 300 nm.

In one embodiment of the method according to the invention, the laser used for performing the laser surface treatment being a laser with a laser beam comprising a wavelength with is absorbable by the glass material constituting the outer surface of the at least one rod, the laser beam preferably include a wavelength about 2.1 μm or more, such as up to 12 μm, such as between 2.5 μm and 11 μm, such as wavelength of around 3, 5 or 10 um.

In most situations the laser is selected so that at least 50% by energy of the laser beam is absorbed by the rod shaped unit. In one embodiment the laser surface treatment is performed using a laser with a laser beam having wavelength in the range where at least 90% by energy, such as at least 95%, such as preferably all of the energy is absorbed by the material of the rod shaped unit.

It is most preferred that the absorbed energy is absorbed in the outermost layer of the rod shaped unit since it is more simple to control the evaporation of glass if the laser beam penetration is not too deep. Thus in one embodiment of the method of the invention, the absorbed energy is absorbed within a layer of 10 μm or less, such as less than 3 μm, determined as the maximal thickness layer removed from outer surface of the rod by one treatment.

One treatment is herein, including in this connection, defined as one treatment of the outer surface with the laser which for each surface segment is followed by a non-treating interval of at least 0.5 second, preferably at least 1 second, more preferably at least 10 seconds, wherein the size of the segment being the size of the striking area of the laser beam.

In one embodiment of the method of the invention, the laser used for performing the laser surface treatment is a laser with a laser beam including a wavelength in the absorbable range of the material constituting the outer surface of the rod and the wavelength and the treatment time are selected so that the thickness layer removed from outer surface of the rod by one treatment is between 1 nm and 10 μm, such as between 10 nm and 5 μm, such as between 100 nm and 1 μm.

In one embodiment, wherein the laser used for performing the laser surface treatment is selected to be a laser with a laser beam including a wavelength in the absorbable range of the material constituting the outer surface of the rod, the wavelength and the treatment time are selected so that the thickness layer removed from outer surface of the rod by one or more treatments is between 1 nm and 1 mm, such as between 100 nm and 100 μm, such as between 1 μm and 10 μm.

If too much is moved in one treatment, there is a risk that damaging marks and irregularities may be created in the surface of the rod shaped unit.

In a preferred method the laser used for performing the laser surface treatment process is a CO₂ laser, or a CO laser.

CO₂ lasers and CO lasers are well known in the art. Examples hereof can e.g. be found in US 2002/0175151 and in Paul A. Temple et al. “Carbon dioxide laser polishing of fused silica surfaces for increased laser-damage resistance at 1064 nm.”

The rod shaped unit may be subjected to one or more laser surface treatments. These laser surface treatments may be performed immediately after each other or with larger time intervals such as one, two or tree hours or even days, weeks or months.

In one embodiment, the rod shaped unit is subjected to two or more laser surface treatments, wherein one laser surface treatment is as defined above. In one embodiment, the rod shaped unit is subjected to two or more laser surface treatments, where the-two or more laser treatments have a treatment intensivity which is similar to each other ±10% by energy. The treatment intensivity is herein defined as the average power output from the laser (W)×the treatment time (s) for the whole outer surface of the rod shaped unit.

In one embodiment, the rod shaped unit is subjected to two or more laser surface treatments, and the two or more laser treatments have a treatment intensivity which is decreasing from one treatment to the following treatment.

In one embodiment, the rod shaped unit is subjected to two or more laser surface treatments, and the thickness layer removed from the outer surface of the rod shaped unit by at least one of the treatments is less than 10 μm, such as less than 1 μm, such as less than 0.1 μm, such as less than 0.01 μm. In one embodiment, the thickness layer removed from the outer surface of the rod shaped unit by two or more of the individual treatments is less than 10 μm, such as less than 1 μm, such as less than 0.1 μm, such as less than 0.01 μm. It is in one embodiment preferred that at least the thickness layer removed from the outer surface of the rod shaped unit in the last laser surface treatment is less than 10 μm, such as less than 1 μm, such as less than 0.1 μm, such as less than 0.01 μm. Thereby a particularly smooth surface is obtained.

By removing small amounts of glass at a time, creation of undesired stress in the material may be avoided.

The power absorbed by the surface of the rod shaped unit may be adjusted by selecting the beam power output, the size of the striking area and the striking time.

The term “striking area” means the area struck simultaneously by a laser beam.

The laser may be a continuous laser or a pulsed laser. In one embodiment, the laser for performing the laser surface treatment is operating with a pulsed laser beam, the pulsed laser beam having a beam duration of from 1 ps to 100 μs. Too high beam durations may be difficult to control as they may result in creating of irregularities.

In one embodiment, the laser for performing the laser surface treatment is operating with a pulsed laser beam, and the pulsed laser beam has a frequency of from 1 KHz to 1 GHz.

When using a pulsed laser for performing the laser surface treatment, the pulsed laser beam may in one embodiment have an average power output of from 10 mW to 1 KW, such as from 1 W to 50 W.

In one embodiment, the laser surface treatment may be performed using a continuous, or quasi-continuous laser beam, the power output from the laser preferably being of from 100 mW to 10 KW, such as from 10 W to 500 W.

The term or quasi-continuous means a laser which may be pulsed but with such short pulse time that it in principle acts as a continuous laser.

In general whether the laser is pulsed or not it is desired that the applied power is in the area of up to about 80 W/mm² surface area of the rod shaped unit, such as between 5 and 70, such as between 10 and 60, such as between 20 and 50, such as around 40 W/mm².

The striking area may in principle have any size, though it is desired that it is not too small since this may require larger precision in controlling the laser surface treatment, and also it should not be too large as this may result in undesired loss of energy.

In one embodiment, the laser beam is arranged to have a striking area of between 0.1 and 100 mm², such as around 5 mm², the striking area may preferably have a length to width dimension which is between 1:1 and 100:1, such as between 2:1 and 50:1, such as between 5:1 and 10:1.

In one embodiment, the laser has a spot area which is between 50% smaller and 100% larger than the striking area, the spot area preferably being between 0.05 and 200 mm².

In order to provide a simple control of the laser surface treatment process it is desired that the striking area of the laser beam is essentially constant during the laser surface treatment, however, in principle it could be varied.

During the laser surface treatment the laser beam and or the rod shaped unit is moved to thereby make sure that the entire surface of the rod shaped unit is treated.

In one embodiment, the laser beam is stepwise or continuously moved relative to the outer surface of the rod shaped unit, the movement preferably being continuous.

In another embodiment the laser beam is held in a fixed position and the rod shaped unit is stepwise or continuously moved, the movement preferably being continuous.

The laser beam may in principle be directed toward the surface of the rod shaped unit in any angel, but in general for simple control of a uniform treatment, it is desired that the laser beam is directed essentially perpendicular onto the outer surface of the rod shaped unit. In this connection the term “essentially perpendicular” is taken to mean within an angle of up to 10 degree, preferably up to 5 degree to a plane going through the center axis of the rod shaped unit and being perpendicular to a straight line through the center of the striking area to the center axis of the rod shaped unit.

The laser beam may in one embodiment be moved over the outer surface of the rod shaped unit to provide a homogenous laser treatment of the outer surface. This can in general be performed by moving the laser beam, by moving the outer surface or by moving both. The movement should preferably be systematic to improve the homogeneity of the laser surface treatment.

In one embodiment, the movement of the laser beam relative to the outer surface is performed by holding the rod shaped unit fixed and moving the laser or one or more mirrors directing the beam towards the surface of rod shaped unit.

In one embodiment, the movement of the laser beam relative to the outer surface is performed by rotating the rod shaped unit. The rod shaped unit may preferably be held in a vertical or a horizontal direction during the rotating thereof.

In one embodiment, the rod shaped unit is held in a vertical direction and rotated while it moved up or down, or the laser beam is moved up or down e.g. using a mirror. By holding the rod shaped unit in vertical direction, the gravity force will influence the rod shaped unit equally along its periphery, and thus the gravity will not result in creation of any undesired asymmetry along the length of the rod shaped unit.

When the rod shaped unit is held in vertical direction it is desired that at least the last laser surface treatment is performed by moving the laser beam from the top of the rod shaped unit to the bottom while the rod shaped unit is rotating. The term top and bottom designate the uppermost periphery, respectively the lower most periphery of the outer surface of the rod shaped unit held in vertical direction.

Simultaneously with the rotation, the laser beam may in one embodiment be moved along the length of the rod shaped unit. The laser beam may be moved by e.g. moving the laser or more simple by moving one or more mirrors reflecting the laser beam towards the rod shaped unit.

In one embodiment, the laser beam is directed from the laser and towards the outer surface of the rod shaped unit via one or more mirrors. This is the most simple way to control the laser beam.

In one embodiment, one or more focusing lenses may be adjusting the laser beam along its way from the laser to the surface of the rod shaped unit. Thus, in one embodiment the laser beam is directed from the laser and towards the outer surface of the rod shaped unit via one or more focusing lenses.

The focusing lens or lenses may e.g. include one or more mirrors and/or one or more optical transparent lens or lenses.

The one or more focusing lenses include a last lens, which is the lens closest to the striking area of the rod shaped unit. In one embodiment, the last lens is positioned such that the shortest distance between the centre of the last lens and the outer surface of the rod shaped unit is from 0.5 to 1.5 times the focal length of said last lens, such as 0.75 to 1.25, such as 0.9 to 1.1, such as 0.95 to 1.05, such as from 0.99 to 1.01 times the focal length of said last lens. The focal length is defined as the length from the centre of the last lens to a distance along the beam where the beam has its spot size.

In one embodiment, the focal length of the emitted laser beam or from the last lens is between 10 and 500 mm, preferably between 25 and 300 mm. In principle the focal length of the emitted laser beam or from the last lens may have any length, however, if it is very short e.g. below 10 mm it may be difficult to control the laser beam and it effect applied onto the surface of the rod shaped unit. If the focal length is long, it requires large space, and if it is very long, the laser beam may loose a significant amount of its power.

As mentioned above, a gas flow should be directed over the surface of the rod shaped unit to remove evaporated glass, dirt and dust. The gas may in principle be any kind of gas which is not reacting with the glass material in an undesired fashion under the temperature condition during the laser cleaning treatment. Also it is preferred that the gas is essentially dust free, so that no new dust is introduced into the system.

Preferred gasses include, but are not limited to one or more of the gasses clean air, N₂, CO₂, Ar. In general all low-reactive gasses are safe to use, but naturally it is desired to select the gas to be of low cost. The gas may in one embodiment be cleaned and be reused in the system. In another embodiment, the used gas is emitted to the environment.

The gas or gas mixture may preferably have a relative humidity degree of less than 50%, such as less than 25%, such as less than 10% such as essentially dry. Thereby the risk of having steam disturbing the laser surface treatment can be avoided.

In one embodiment, the gas flow is flowing along the outer surface of the rod shaped unit at least in an area including the laser beam. The flow may in principle be directed in any directing, but preferably it is directed in the length direction of the rod shape unit, thereby avoiding redepositing of evaporated matter onto areas of the surface which has already been treated.

In one preferred embodiment of the method according to the invention, where the rod shaped unit is subjected to laser surface treatment and the treatment is performed from a first one of its ends toward the second one of its ends, the gas flow is directed in the length direction of the rod shape unit so that the direction of the gas flow is following the lengthwise treatment direction. The lengthwise treatment direction is the direction from the first to the second end of the rod shaped unit.

In one embodiment it is desired that the flow is essentially laminar in order to minimize risk of moving evaporated glass, dirt and dust to deposit on already treated surface sections. But turbulent flow may in one embodiment be used.

The gas flow should preferably be arranged to remove evaporated glass, dirt and dust from the treated surface. This may e.g. be obtained by selecting the flow direction and the flow level in accordance to the amount of evaporated glass, dirt and dust to be removed.

In one embodiment where the flow is a laminar flow, it is desired that the flow rate is sufficiently high to remove the evaporated glass molecules. The flow rate may e.g. be at least 0.1 m/s, such as at least 0.2 m/s, such as between 0.25 and 1 m/s, such as between 0.35 and 0.75 m/s.

In one embodiment, the flow is arranged as an annular flow curtain to flow along the outer surface from one end (called the first end) of the rod shaped unit to the other end thereof (called the second end). The flow curtain preferably has a thickness which is sufficient to carry evaporated glasses away from the outer surface of the rod shaped unit. The flow curtain thickness may e.g. be at least 1 μm, such as at least 0.5 mm, such as around 1 cm, more preferably the thickness of the flow curtain being at least as thick as the maximal diameter of the rod shaped unit under treatment.

The skilled person will know how to arrange the flow of gas based on the above instruction to remove the evaporated gas and any possibly dirt and dust.

It is desired that the laser surface treatment performed on the outer surface of the one or more rod shaped unit(s) is/are essentially homogenous over the outer surface of the one or more rod shaped unit(s).

In one embodiment, the rod shaped unit is a holey rod comprising a hole extending along its length, e.g. in the form of a tube, such as a capillary tube. The holey rod may in one embodiment be subjected to an additional laser surface treatment (an inner surface laser treatment) performed on the inner surface provided by the hole of the holey rod shaped unit. This inner surface laser treatment preferably being essentially homogenous over the inner surface of the rod shaped unit.

For performing the inner surface laser treatment it is desired that the hole has a sufficient diameter to introduce a mirror into the hole to thereby direct the laser beam towards the inner surface. The hole may thus in one embodiment have a largest diameter of at least 1 mm, such as at least 2 mm, such as at least 3 mm. It should be observed that the hole may have any cross sectional outer periphery such as circular, oval, triangular, square formed, pentagonal, hexagonal.

The laser surface treated rod shaped unit is applied in intimate contact with a second unit after termination of the laser surface treatment. The term “intimate contact” means that at least a part of the surface area of the rod shaped unit is in physical contact with the surface of a second unit. The units need not initially be bonded to each other, it is sufficient that they are held close together e.g. by inserting them into a holder. In most situations, however, the units are sintered or fused to adhere to each other, such as it is generally known when stacking rod shaped units for a preform. Examples hereof are disclosed in WO 0037974 and in J. C. Knight et al. “PURE SILICA SINGLE-MODE FIBRE WITH HEXOGONAL PHOTONIC CRYSTAL CLADDING”.

The contact between the laser surface treated rod shaped unit and the second unit (which may also be a laser surface treated rod shaped unit) may be established immediately after the treatment or several hours, days, or even month after the treatment. Care should however be taken that the laser surface treated rod shaped unit is not contaminated with dust and similar during stocking.

In one embodiment, the laser surface treated rod shaped unit is applied in intimate contact with a second unit immediately after terminating of the laser surface treatment.

In another embodiment, the laser surface treated rod shaped unit is kept in clean room until it is applied in intimate contact with a second unit. If stored in clean room, it is in most situations desired that the laser surface treated rod shaped unit preferably is applied in intimate contact with a second unit within 48 hours, such as within 24 hours, such as within 5 hours after termination of the laser surface treatment.

In one embodiment, the laser surface treated rod shaped unit is stored in protected surroundings. In this situation laser surface treated rod shaped unit may be stored for month or even longer. The protected surroundings may e.g. be established by using a closed storing , preferably a closed storing tube filled with a cleaned gas, such as clean air, N₂, CO₂, Ar, or the tube may be evacuated to a pressure of 10 mbar or less, such as 1000 μbar or less, such as around 100 μbar or less.

The rod shaped unit used in the method of the invention may in principle have any size. The size will in general be selected in dependence of the desired end fiber, the size of the drawing tower or extrusion equipment e.g. a die, which is available for modifying the preform to become a fiber.

In one embodiment, the rod shaped unit has a largest cross-sectional dimension from 0.1 mm to 250 mm, such as from 1 to 10 mm. The rod shaped units may preferably be circular or hexagonal with equal sides, the cross-sectional average diameter preferably being 0.1 mm to 250 mm, such as from 1 to 10 mm.

In one embodiment, the rod shaped unit has a length of at least 5 mm, such as up to 10 m, such as from 10 mm to 2 m, such as from 20 cm to 1.5 m, such as from 30 cm to 1.0 m. The preform may in one embodiment be made in longer length, which prior to drawing or extrusion is cut into smaller length.

In one embodiment, the rod shaped unit has a length which is its largest cross-sectional dimension. The length to largest cross-sectional dimension proportion may preferably be in the interval from 1:1 to 2000:1, such as from 50:1 to 1000:1.

In one embodiment, the second unit is a silica containing sol, the laser surface treated rod shape unit being brought in intimate contact with the second unit by applying it in a vessel in side by side relationship with the sol. Generally it is preferred in this embodiment that at least two or more laser surface treated rod shape units (preferably holey rod shaped units) are brought in intimate contact with the sol.

Prior art examples of preforms produced from rods and silica containing sol are e.g. disclosed in WO 03078338.

In one embodiment, the second unit is a second rod shaped unit, and the laser surface treated rod shape unit is brought in intimate contact with the second unit by applying it in a side by side relationship, such as it is known when stacking tubes as explained above. In this embodiment it is desired that the second unit in the form of a rod shaped unit is also subjected to a laser surface treatment.

In one embodiment, a plurality of rod shaped units are stacked and preferably the entire rod shaped units are subjected to a laser surface treatment.

In one embodiment, the second unit is a sleeve applied to surround the outer surface of the laser surface treated rod shaped unit or a plurality of stacked and shaped units, which have been subjected to laser surface treatments, the laser surface treated rod shape unit is brought in intimate contact with the sleeve by applying the sleeve to around the laser surface treated rod shaped unit or units.

In one embodiment, where the preform comprises a plurality of rod shaped units, the rod shaped units may have identical or different shapes. The rod shaped units are preferably stacked to form the preform. In general it is desired that the stacked rod shaped units have identical length, but they may very well vary with respect to diameter, shape of outer periphery, holey or solid or varying with respect to its material. Variations of this type as well as other variations with respect to shape and size may be applied and are further well known in tea art and are e.g. disclosed in WO 0037974 and in J. C. Knight et al. “PURE SILICA SINGLE-MODE FIBRE WITH HEXOGONAL PHOTONIC CRYSTAL CLADDING”.

In one embodiment, the rod shaped units brought into intimate contact are held together by an outer (removable or non-removable) casing, such as a glass tube.

In one embodiment, the method includes bringing laser surface treated rod shaped units into intimate contact with each other by stacking, one or more, such as six or more, of the rod shaped units are holey rods comprising at least one hole extending along its length.

In this embodiment is it preferred that wherein the respective holes in the holey rod shaped units have cross sectional outer periphery which are selected from the group consisting of circular, oval, triangular, square formed, pentagonal, hexagonal, the cross sectional outer periphery of the hole constitutes the cross sectional inner periphery of the rod shaped unit wall.

The holey rod shaped units may in one embodiment each have a cross sectional outer periphery which is of similar shape as the cross sectional inner periphery of the rod, to thereby provide a wall with a uniform thickness at least in a cross sectional cut.

In one embodiment, one or more, e.g. all of the holey rod shaped units have a cross sectional outer periphery which is of a different shape than the cross sectional outer periphery of the rod, to thereby provide a wall with a non-uniform thickness in a cross sectional cut.

The average wall thickness of the one or more holey rod shaped units may e.g. be from 0.1 mm to 50 mm, such as from 0.2 to 10 mm, such as from 0.5 to 2 mm.

In one embodiment, the inner surface of the one or more holey rod shaped units is subjected to a laser surface treatment, the gas includes a flow through the hole of the holey rod shaped unit. The gas flow may be as described above for the gas flow along the outer surface during laser surface treatment of the outer surface of the rod shaped unit.

In one embodiment, where the holey rod shaped units are of glass the one or more holey rod shaped units are further subjected to an inner surface laser cleaning step, to thereby remove impurities from the inner surface. This laser cleaning step in the inner surface may be superfluous if the holey rod shaped unit has also been subjected to an inner surface laser treatment as described above. The inner surface laser treatment and the inner surface laser cleaning step should thus be seen as alternatives to each other.

The inner surface laser cleaning as described below may also be used independently of the laser surface treatment of the outer surface of the rod shaped unit.

Thus the invention also relates to a method of cleaning the inner surface of a holey glass tube.

The inner surface laser cleaning step comprising the steps of directing a cleaning laser beam onto the outer surface of the holey rod shaped unit, while simultaneously providing a gas flow through the hole of the holey rod shaped unit, where the cleaning laser beam comprising at least one wavelength which is not absorbed by the glass material.

During the inner surface laser cleaning, the laser beam penetrates the glass wall of the holey rod shaped unit with only little or no absorbance by the glass. As the laser beam is exiting the glass wall it strikes dirt and impurities, including organic impurities on the inner surface, which dirt and impurities absorb light and thereby are burned of and removed via the gas flow.

In one embodiment of inner surface laser cleaning, the laser beam for cleaning the inner surface comprises at least one wavelength in the range of from 350 nm to 2.1 μm, such as a wavelength around 1 μm.

Preferred lasers include, but are not limited to an Nd:YAG.

The direction and the control of directing the laser beam to the outer surface of the rod shaped unit may be as described above for the method of making a preform.

In order to have a high effect without heating the glass too much during the cleaning it is desired that the cleaning laser used for performing the cleaning of the inner surface is a cleaning laser with a cleaning laser beam in the range where at least 90% by energy, such as at least 95%, such as at least 98% of the light is penetrating through the material from its outer surface and out of its inner surface to the hole of the holey rod shaped unit.

The laser may be pulsed, quasi pulsed or continuous as e.g. disclosed above for the laser for the laser surface treatment of the outer surface of the rod shaped unit. The laser may have output as disclosed above for the laser for the laser surface treatment of the outer surface of the rod shaped unit.

Thus, in one embodiment the cleaning laser for cleaning of the inner surface is operated with a pulsed cleaning laser beam having a beam duration of from 10 ps to 100 μs. The pulsed cleaning laser beam may e.g. have a frequency of from 1 KHz to 1 GHz.

Also the striking area and the spot area may be as disclosed above for the laser surface treatment of the outer surface of the rod shaped unit.

The cleaning laser beam for cleaning the inner surface may be stepwise or continuously moved over the surface of the rod shaped unit, the movement preferably being continuous.

In one embodiment, wherein the cleaning laser beam is moved over the surface of the rod shaped unit to clean all of the inner surface, the cleaning laser penetrates through the glass material of the rod shaped unit and is at least partly absorbed by dirt, such as organic material at the inner surface, whereby by at least some of the dirt is decomposed and/or evaporated.

The cleaning laser beam may be stepwise or continuously moved relative to the surface of the rod shaped unit, the movement preferably being continuous. The movement may be as the movement described above during the laser surface treatment of the outer surface of the rod shaped unit

The cleaning laser beam may in one embodiment be directed from the cleaning laser and towards the surface of the rod shaped unit via one or more focusing lenses, and/or mirrors as described above for the laser surface treatment of the outer surface of the rod shaped unit, and also the focal length may be as described above.

The gas and the gas flow may additionally be as described above for the laser surface treatment of the outer surface of the rod shaped unit.

The invention also relates to a method of making a preform for an optical fibre comprising the steps of
i) providing at least one holey rod shaped unit comprising at least one hole extending along its length, an inner outer surface of glass, such as amorphous silica glass,
ii) subjecting said at least one rod shaped unit to a laser surface treatment by directing a laser beam onto its inner surface to thereby evaporate glass from the surface, while simultaneously providing a gas flow to thereby remove the evaporated glass, and
iii) optionally applying the treated rod shape unit in intimate contact with a second unit so that at least a part of the surface of the rod shaped unit that has been subjected to a laser surface treatment is in intimate contact with the second unit.

In this method the inner surface of a holey rod shaped unit is subjected to a laser surface treatment.

The laser, the power output and control thereof may be as described above for performing the outer surface laser treatment.

The holey rod shaped unit may be as described above. The hole should have a sufficient diameter to introduce a mirror into the hole to thereby direct the laser beam towards the inner surface, the hole preferably have a largest diameter of at least 1 mm, such as at least 2 mm, such as at least 3 mm.

The holey fiber may have a size and shape as disclosed above provided that the hole has a sufficient diameter to introduce a mirror into the hole.

The treatment may be performed as described above for the outer surface laser treatment of a holey rod shaped unit with the only difference that the laser beam is directed towards the inner surface of the holey rod shaped unit, and that the gas flow is provided through the hole of the holey rod shaped unit.

One or more mirrors preferably are inserted into the hole of the holey rod shaped unit.

The invention also relates to the preform obtainable using the methods described above, and in particular a preform comprising a rod shaped unit in intimate contact with a second unit, the interface between the units being essentially free of organic material.

The invention also relates to rod shaped unit obtainable by subjecting its outer or inner surface to a laser surface treatment process using a laser with a laser beam comprising a wavelength with is absorbable by the glass material constituting the inner surface of the at least one rod, the laser beam preferably include a wavelength about 300 nm or less, such as between 130 nm and 300 nm, the laser preferably being a CO₂ laser, or a CO laser, the laser surface treatment preferably being essentially homogenous over its inner and/or outer surface.

The rod shaped unit may e.g. be stored in protected surroundings as described above, such as in a closed storing tube, the closed storing tube preferably being filled with a cleaned gas, such as clean air, N₂, CO₂, Ar, or the tube being evacuated to a pressure of 10 mbar or less, such as 1000 μbar or less, such as around 100 μbar or less.

The invention also relates to fiber made from a preform as described above. The fiber is preferably made from a preform composed of a plurality of rod shaped units by pulling and/or extruding the fiber. The fiber preferably has an attenuation which at wavelength from 1510-1640 is 1 db/KM or less, such as about 0.5 db/KM or less

### BRIEF DESCRIPTION OF DRAWING AND EXAMPLES

FIG. 1 shows a setup of a rod shaped unit during laser surface treatment.

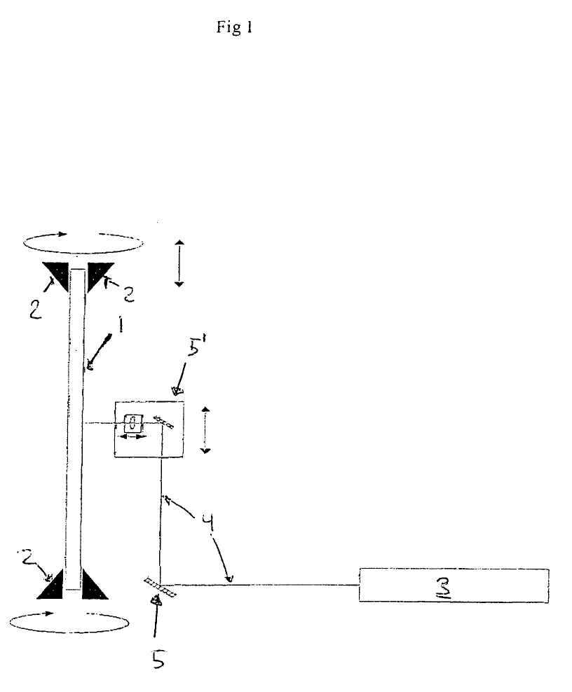

In FIG. 1 a rod shaped unit 1 e.g. a capillary tube is fixed by chucks 2 in either ends and rotated about its axis of symmetry. A laser 3 is directing a laser beam 4 via mirrors and lens system 5 to the surface of the capillary tube 1. The lens system 5 comprises a fixed mirror 5 and a movable lens/mirror system 5′ which is placed on a translational stage.

### EXAMPLE 1

A capillary tube or rod is fixed by chucks in either ends and rotated about its axis of symmetry. The system may be as simple as that shown in FIG. 1. A CO₂ laser beam is sent to a fixed mirror 5 at the lower chuck. The beam is then directed towards another mirror 5′ which is placed on a translational stage. The latter mirror directs the laser beam perpendicularly onto the surface of the element through a cylindrical lens. The axis of the lens is parallel to that of the rod shaped unit, hence making an elongated laser spot along the axis of the rod shaped unit. The chosen lens system will depend on the specifications of the chosen CO₂ laser, e.g. a beam expander can be added if the laser beam is too narrow. The glass surface will preferably be within few millimeters from the focus. While the rod shaped unit is rotating the translational stage is moved along the rod shaped unit, hence the whole surface will have been exposed to the laser beam. It is important that the evaporating glass dust is not allowed to redeposit on the already processed area. This can be avoided by preferably an air extracting hose held nearby the process area and slightly to the side of the unprocessed area. Alternatively a slow flow of clean air or N₂ can be used for directing the glass dust away from the processed part.

The reason for choosing a cylindrical lens in this example is that it allows both a high enough intensity for evaporating the glass surface and a slow heating and cooling rate.

The typical process parameters are amount of defocusing, rotational speed, traverse speed, laser power, beam width, and pulse length in case of a pulsed laser. The size of the rod shaped unit may limit the choice of process parameters, since the rod shaped unit risk to soften and bend for some parameter choices.

### EXAMPLE 2

A laser surface treatment that was carried out for treating a rod shaped unit which was placed horizontally and set to rotate in horizontal position. The focal length of the cylindrical lens was +250 mm. The laser in use was an air cooled Coherent GEM 100A offering a maximum power of 100 Watts. This is a type of laser that varies the power by varying the duty cycle. The preferred operational mode was CW. In this test run a rather thick rod shaped unit having a diameter of 4.1 mm and with deep scratches was used. The result showed that only a small amount of the glass was evaporated which was not enough to remove the deepest scratches. It was not possible to measure any reduction of the diameter, but evaporating glass dust was visible. By visual inspection the improved cleanliness was easily seen.

### EXAMPLE 3

First scheme is for removing impurities, especially organic films and deposits. The silica tube that is to be cleaned is clamped and rotated about its axis of symmetry. A high power laser beam with a wavelength reasonably within the transparent region of the silica is sent perpendicularly towards the tube axis. The laser can be CW or pulsed and it can be e.g. an Nd:YAG laser which is commercially available and at modest costs. The light will be absorbed by the impurities and causing these to decompose or evaporate. The laser beam is brought to traverse along the tube axis at a speed that ensures that the entire glass surface has been radiated. A flow of clean gas, e.g. N₂ is sent through the tube in the same direction as the traverse direction of the laser beam, hence bringing the exhaust gas from the impurity removal from the cleaned area. In this scheme the outside is also cleaned and an axial gas flow could also be considered if no other outer cleaning procedure is used.

1. A method of making a preform for an optical fiber comprising the steps of
i) providing at least one rod shaped unit comprising an outer surface of glass,
ii) subjecting said at least one rod shaped unit to a laser surface treatment by directing a laser beam onto its outer surface to thereby evaporate glass from the surface, while simultaneously providing a gas flow to thereby remove the evaporated glass, and
iii) applying the treated rod shape unit in intimate contact with a second unit so that at least a part of the surface of the rod shaped unit that has been subjected to a laser surface treatment is in intimate contact with the second unit.

2. A method according to claim 1, wherein the at least one rod shaped unit is holey, meaning that it comprises at least one hole extending along the length of the rod.

3. A method according to claim 1, wherein the at least one rod shaped unit is of amorphous silica glass.

4. A method according to claim 1, wherein at least one rod shaped unit comprises doped glass.

5. A method according to claim 1, wherein the laser used for performing the laser surface treatment process is a CO₂ laser or a CO laser, the laser beam preferably being directed essentially perpendicular onto the outer surface of the rod shaped unit.

6. A method according to claim 1, wherein the laser used for performing the laser surface treatment is a laser with a laser beam comprising a wavelength with is absorbable by the glass material constituting the outer surface of the at least one rod.

7. A method according to claim 6, wherein the wavelength and the treatment time being selected so that the thickness layer removed from outer surface of the rod by one treatment is between 1 nm and 1 mm.

8. A method according to claim 1, wherein the at least one rod is subjected to two or more laser surface treatments, one laser surface treatment being defined as one treatment of the outer surface with the laser which for each surface segment is followed by a non-treating interval of at least 0.5 second, the size of the segment being the size of the striking area of the laser beam.

9. A method according to claim 1, wherein the laser beam is arranged to have a striking area of between 0.1 and 100 mm².

10. A method according to claim 1, wherein the laser beam is stepwise or continuously moved relative to the outer surface of the rod shaped unit, the movement preferably being continuous.

11. A method according to claim 10 wherein the laser beam is held in a fixed position and the rod shaped unit is stepwise or continuously moved, the movement preferably being continuous.

12. A method according to claim 10 wherein the laser beam is moved over the outer surface of the rod shaped unit to provide a homogenous laser treatment of the outer surface.

13. A method according to claim 10, wherein the movement of the laser beam relative to the outer surface is performed by rotating the rod shaped unit, the rod shaped unit preferably being held in a vertical or a horizontal direction during the rotating thereof.

14. A method according to claim 13, wherein the laser beam is moved along the length of the rod shaped unit whilst the rod shaped unit is rotated.

15. A method according to claim 1 wherein the laser beam is directed from the laser and towards the outer surface of the rod shaped unit via one or more focusing lenses.

16. A method according to claim 1, wherein the gas flow is a flow of one or more essentially dust free gasses.

17. A method according to claim 1, wherein the gas flow is a flow comprising one or more of the gasses selected from the group consisting of clean air, N₂, CO₂, Ar and mixtures thereof.

18. A method according to claim 1, wherein the gas has a relative humidity degree of less than 50%, such as less than 25%, such as less than 10% such as essentially dry.

19. A method according to claim 1, wherein the gas flow is flowing along the outer surface of the rod shaped unit at least in an area including the laser beam.

20. A method according to claim 19 wherein the gas flow is directed in the length direction of the rod shape unit, the direction of the gas flow following the lengthwise treatment direction.

21. A method according to claim 19, wherein the flow is a laminar flow.

22. A method according to claim 19, wherein the flow is arranged as a annular flow curtain to flow along the outer surface from one end of the rod shaped unit to the other end thereof.

23. A method according to claim 1 wherein the flow is a tubular flow.

24. A method according to claim 2, wherein the laser surface treatment further being performed on the inner surface provided by the hole of the at least one rod shaped unit.

25. A method according to claim 1, wherein the laser surface treated rod shaped unit is applied in intimate contact with a second unit immediately after termination of the laser surface treatment.

26. A method according to claim 1, wherein the laser surface treated rod shaped unit is kept in clean room until it is applied in intimate contact with a second unit.

27. A method according to claim 1, wherein at least one rod shaped unit is subjected to an outer laser surface treatment, the second unit being a second rod shaped unit, the laser surface treated rod shape unit being brought in intimate contact with the second unit by applying it in a side by side relationship, the preform comprises a plurality of rod shaped units, the rod shaped units having identical or different shapes, the rod shaped units being stacked to form the preform.

28. A method according to claim 24, wherein the inner surface of the one or more holey rod shaped units is subjected to a laser surface treatment, the gas includes a flow through the hole of the holey rod shaped unit.

29. A method according to claim 24, wherein the one or more holey rod shaped units are of glass and the one or more holey rod shaped units are further subjected to an inner surface laser cleaning step, to thereby remove impurities from the inner surface.

30. A method of cleaning the inner surface of a holey glass tube comprising the steps of directing a cleaning laser beam onto the outer surface of the holey rod shaped unit, while simultaneously providing a gas flow through the hole of the holey rod shaped unit, the cleaning laser beam comprising at least one wavelength which is not absorbed by the glass material.

31. A method according to claim 30, wherein the cleaning laser beam for cleaning the inner surface comprises at least one wavelength in the range of from 350 nm to 2.1 μm.

32. A method according to claim 30, wherein the cleaning laser beam being directed essentially perpendicular onto the surface of the rod shaped unit.

33. A method according to claim 30, wherein the cleaning laser beam for cleaning the inner surface is stepwise or continuously moved over the surface of the rod shaped unit.

34. A method according to claim 30 wherein the cleaning laser beam is moved over the surface of the rod shaped unit to clean the inner surface, the cleaning laser penetrating through the glass material of the rod shaped unit and being at least partly absorbed by dirt, so that at least some of the dirt is removed.

35. A method according to claim 30, wherein the gas flow is a flow of one or more essentially dust free gasses.

36. A method according to claim 30, wherein the gas flow is a flow comprising one or more of the gasses selected from the group consisting of clean air, N₂, CO₂, Ar, and mixtures thereof.

37. A method according to claim 30, wherein the gas has a relative humidity degree of less than 50%.

38. A method according to claim 30, wherein the gas flow is directed through the hole of the holey rod shaped unit, the direction of the flow follows the lengthwise treatment direction.

39. A method according to claim 30, wherein the flow is a laminar flow.

40. A method of making a preform for an optical fiber comprising the steps of
iv) providing at least one holey rod shaped unit comprising at least one hole extending along its length, an inner outer surface of glass, such as amorphous silica glass,
v) subjecting said at least one rod shaped unit to a laser surface treatment by directing a laser beam onto its inner surface to thereby evaporate glass from the surface, while simultaneously providing a gas flow to thereby remove the evaporated glass, and
vi) optionally applying the treated rod shape unit in intimate contact with a second unit so that at least a part of the surface of the rod shaped unit that has been subjected to a laser surface treatment is in intimate contact with the second unit.

41. A method according to claim 40 wherein the hole has a sufficient diameter to introduce a mirror into the hole to thereby direct the laser beam towards the inner surface.

42. A method according to claim 40, wherein the laser used for performing the laser surface treatment process is a laser with a laser beam comprising a wavelength with is absorbable by the glass material constituting the inner surface of the at least one rod.

43. A method according to claim 40, wherein the inner surface of at least one rod is subjected to two or more laser surface treatments.

44. A method according to claim 40, wherein the laser beam is stepwise or continuously moved relative to the inner surface of the rod shaped unit, the movement preferably being continuous.

45. A method according to claim 40 wherein the laser beam is directed from the laser and towards the inner surface of the rod shaped unit via one or more mirrors, at least one of the mirrors being inserted into the hole of the holey rod shaped unit.

46. A method according to claim 40, wherein the gas flow is a flow of one or more essentially dust free gasses.

47. A preform for an optical fiber, the preform comprising a rod shaped unit in intimate contact with a second unit, the interface between the units being essentially free of organic material.

48. A rod shaped unit obtainable by subjecting its outer or inner surface to a laser surface treatment process using a laser with a laser beam comprising a wavelength with is absorbable by the glass material constituting the inner surface of the at least one rod.

49. A fiber made from a preform composed of a plurality of rod shaped units by pulling the fiber, the fiber having an attenuation which at wavelength from 1510-1640 is 1 db/KM or less, such as about 0.5 db/KM or less.

50. A perform according to claim 47, wherein the second unit is rod shaped.
